(19) United States
(12) Patent Application Publication
(10) Pub. No.: US 2022/0410914 A1
(43) Pub. Date: Dec. 29, 2022

(54) MULTI-AGENT CONTROL SYSTEM

(71) Applicant: DAEGU GYEONGBUK INSTITUTE OF SCIENCE AND TECHNOLOGY, Daegu (KR)

(72) Inventors: Gyu Jin NA, Gimcheon-si (KR); Yong Soon EUN, Daegu (KR); Ye Chan JEONG, Seoul (KR)

(21) Appl. No.: 17/780,163

(22) PCT Filed: Sep. 29, 2020
(86) PCT No.: PCT/KR2020/013411

§ 371 Date: May 26, 2022

(30) Foreign Application Priority Data
Nov. 27, 2019 (KR) 10-2019-0154781

(51) Int. Cl. B60W 50/029; G07C 5/00; G07C 5/08; B60W 50/02

(52) U.S. Cl. CPC B60W 50/029; G07C 5/008; G07C 5/0808; B60W 50/0205; G08G 1/22

(57) ABSTRACT

In a preferred example embodiment of the present disclosure, a multi-agent control system includes: a malfunctioning-agent detector configured to detect a malfunctioning agent among a plurality of agents based on a malfunction signal received from each of the plurality of agents; and a multi-agent controller configured to control a neighboring agent around the malfunctioning agent to transmit a correction control signal to the malfunctioning agent such that the plurality of agents operate in a platoon.

### CROSS-REFERENCE TO RELATED APPLICATION

Pursuant to 35 U.S.C. § 119, this application claims the benefit of earlier filing date and right of priority to Korean Application No. 10-2019-0154781, filed on Nov. 27, 2019, the contents of which are all hereby incorporated by reference herein in their entirety.

### TECHNICAL FIELD

The present disclosure relates to a method of coping with a malfunction of a certain agent in a multi-agent control system, and more particularly, to a method of controlling an agent having a malfunction occurred therein using a neighboring agent when the malfunction occurs in an arbitrary agent in a multi-agent control system.

### BACKGROUND

In the case in which an actuator, a vehicle sensor, or the like of a vehicle driving in an autonomous platoon malfunctions, a study is under way on a method of detecting such a malfunction. However, this method is directed to a method of detecting the malfunction by a specific vehicle itself. When a malfunction is detected to be occurred in a specific vehicle such as a platooning vehicle in a multi-agent control system, as a method of solving such a matter, there has been proposed a method of allowing other vehicles in the multi-agent control system, which drive in a platoon, to detect a malfunctioning vehicle.

### RELATED ART DOCUMENTS

[1] B. P. Jeppesen, D. Cebon, “Analytical redundancy techniques for fault detection in an active heavy vehicle suspension,” Vehicle System Dynamics, vol. 42, no. 1-2, pp. 75-88, 2004.

[2] T. X. Mei, X. J. Ding, “A model-less technique for the fault detection of rail vehicle suspensions,” Vehicle System Dynamics, vol. 46, pp. 277-287, 2008.

[3] Z. Gao, S. X. Ding, Y. Ma, “Robust fault estimation approach and its application in vehicle lateral dynamic systems,” Optimal Control Applications and Methods, vol. 28, pp. 143-156, 2007.

[4] D. Fischer, M. Borner, J. Schmitt, R. Isermann, “Fault detection for lateral and vertical vehicle dynamics,” Control Engineering Practice, vol. 15, pp. 315-324, 2007.

[5] S. Ibaraki, M. Tomizuka, “Design of luenberger state observers using fixed-structure H optimization and its application to fault detection in lane-keeping control of automated vehicles,” IEEE/ASME Transactions on Mechatronics, vol. 10, no. 1, pp. 34-42, 2005.

[6] R. Rajamani, A. S. Howell, C. Chen, J. K. Hedrick, M. Tomizuka, “A complete fault diagnostic system for automated vehicles operating in a platoon,” IEEE Transactions on Control Systems Technology, vol. 9, no. 4, pp. 553-564, 2001.

[7] Z. A. Biron, P. Pisu “Distributed fault detection and estimation for cooperative adaptive cruise control system in a platoon,” PHM conference, 2015.

[8] H. Shim, G. Park, Y. Joo, J. Back, and N. H. Jo, “Yet another tutorial of disturbance observer: robust stabilization and recovery of nominal performance,” Control Theory and Technology, vol. 14, no. 3, pp. 237-249.

[9] G. Na, G. Park, V. Turri, K. H. Johansson, H. Shim, and Y. Eun, “Disturbance observer approach for fuel-efficient heavy-duty vehicle platooning,” Vehicle System Dynamics, vol. 58, no. 5, pp. 748-767, 2020.

[10] X. Jin, et al., “An adaptive learning and control architecture for mitigating sensor and actuator attacks in connected autonomous vehicle platoon,” International Journal of Adaptive Control and Signal Processing, vol. 33, pp. 1788-1802, 2019.

[11] C. Lee, H. Shim, and Y. Eun, “On redundant observability: from security index to attack detection and resilient state estimation,” IEEE Trans. Automatic control, vol 64, no. 2, pp. 775-782, 2018.

[12] K. Hashimoto, M. Chong, and D. V. Dimarogonas, “Realtime 11 fault and state estimation for multi-agent systems,” ACC, pp. 1175-1180, 2019.

### SUMMARY

The present disclosure provides a preferred example embodiments of a method of allowing a neighboring agent around a certain agent in which a malfunction has occurred to control the certain agent, when the certain agent in a multi-agent control system, including vehicles driving in an autonomous platooning, drones flying in a swarm flight, or the like, is in an abnormal state, or erroneously operates due to an external cyber physical attack or the like.

Further, the present disclosure provides another preferred example embodiment of a method of allowing a neighboring agent around a certain agent in which a malfunction has occurred to temporarily performing a function of the certain agent when the certain agent malfunctions in a multi-agent control system.

According to a preferred example embodiment of the present disclosure, in a multi-agent control system for controlling a plurality of agents to operate in a platoon, each of the plurality of agents includes: an actuator; a sensor unit including at least one sensor; a controller configured to control the actuator, the sensor unit, and each agent using an internal control signal; a malfunction detector configured to generate a malfunction signal by detecting a malfunction of the actuator, the sensor unit, or the controller; and a switch configured to perform a switching operation based on the malfunction signal such that the controller uses a correction control signal received from at least one neighboring agent among the plurality of agents instead of the internal control signal. The multi-agent control system includes: a malfunctioning-agent detector configured to detect a malfunctioning agent among the plurality of agents based on the malfunction signal received from each of the plurality of agents; and a multi-agent controller configured to control the at least one neighboring agent to transmit the correction control signal to the malfunctioning agent such that the plurality of agents operate in the platoon.

In a preferred example embodiment of the present disclosure, the correction control signal is generated based on a position estimation vector and a velocity estimation vector of the malfunctioning agent, which are calculated by the at least one neighboring agent.

In a preferred example embodiment of the present disclosure, the malfunction detector is configured to detect an error of the sensor unit provided in an i-th agent Vᵢ based on differences between a position estimation vector [symbol] and a velocity estimation vector [symbol] of a neighboring agent Vᵢ₊₁ around the i-th agent Vᵢ, which are calculated by the i-th agent Vᵢ among the plurality of agents, and a position data vector \tilde{s}ᵢ₊₁ and a velocity data vector \tilde{v}ᵢ₊₁ which are actually measured by the neighboring agent Vᵢ₊₁, which are received from the neighboring agent Vᵢ₊₁.

In another preferred example embodiment of the present disclosure, a multi-agent control system includes: a plurality of agents; and a multi-agent controller configured to communicate with the plurality of agents to control the plurality of agents, wherein each of the plurality of agents includes a sensor unit, a transceiver, and a malfunction detector, the malfunction detector is configured to transmit malfunction information of a malfunctioning agent to the multi-agent controller through the transceiver. When receiving the malfunction information from the malfunction detector, the multi-agent controller is configured to select at least one neighboring agent, which is capable of controlling the malfunctioning agent from which the malfunction information is transmitted among the plurality of agents, and connect the selected at least one neighboring agent and the malfunctioning agent to establish the communication therebetween, and the selected at least one neighboring agent is configured to transmit a state estimation vector of the malfunctioning agent to the malfunctioning agent to control the malfunctioning agent.

In another preferred example embodiment of the present disclosure, in the multi-agent control system, the selected at least one neighboring agent is configured to observe a motion of the malfunctioning agent in real time to calculate the state estimation vector of the malfunctioning agent.

In another preferred example embodiment of the present disclosure, the malfunctioning agent is configured to operate using, as a correction control signal, the state estimation vector received from the at least one neighboring agent, instead of an internal control signal generated by the malfunctioning agent.

According to a multi-agent control system of a preferred example embodiment of the present disclosure, even if a malfunction has occurred in an agent such as a vehicle driving in an autonomous platooning or a drone flying in a swarm flight, it is possible to control the malfunctioning agent to drive in a platoon using a correction control signal provided from a neighboring agent around the malfunctioning agent.

Thus, it is possible to prevent in advance an accident that may occur during the platooning or the swarm flight.

Furthermore, it is possible to improve safety for an autonomous platooning or autonomous drone flight.

### BRIEF DESCRIPTION OF THE DRAWINGS

FIG. 1 illustrates a block diagram of a multi-agent control system that controls a plurality of agents to operate in a platoon, according to a preferred example embodiment of the present disclosure.

FIG. 2 illustrates an example in which an autonomous platooning in the multi-agent control system according to a preferred example embodiment of the present disclosure.

FIG. 3 illustrates an example in which, when a malfunction has occurred in one of a plurality of agents driving in the autonomous platooning malfunctions, a neighboring agent around the malfunctioning agent controls the malfunctioning agent according to a preferred example embodiment of the present disclosure.

FIG. 4 illustrates a control system for controlling an i-th agent that drives in the autonomous platooning according to a preferred example embodiment of the present disclosure.

### DETAILED DESCRIPTION

In the following description, example embodiments of the present disclosure will be described in detail with reference to the accompanying drawings so that those skilled in the art can easily carry out the present disclosure. The present disclosure may be embodied in many different forms and is not limited to the example embodiments described herein. Further, in order to clearly describe the present disclosure, detailed descriptions of parts irrelevant to the present disclosure will be omitted in the drawings, and the same reference numerals will be given to the same constituent elements throughout the specification.

Throughout the specification, when one constituent element is referred to as being “connected” to another constituent element, the one constituent element may be directly connected to another constituent element, or may be connected to another constituent element by intervening yet another constituent element therebetween. Further, when a part “includes” a constituent element through the specification, this means that the part may further include other constituent elements, rather than excluding other constituent elements, unless stated otherwise.

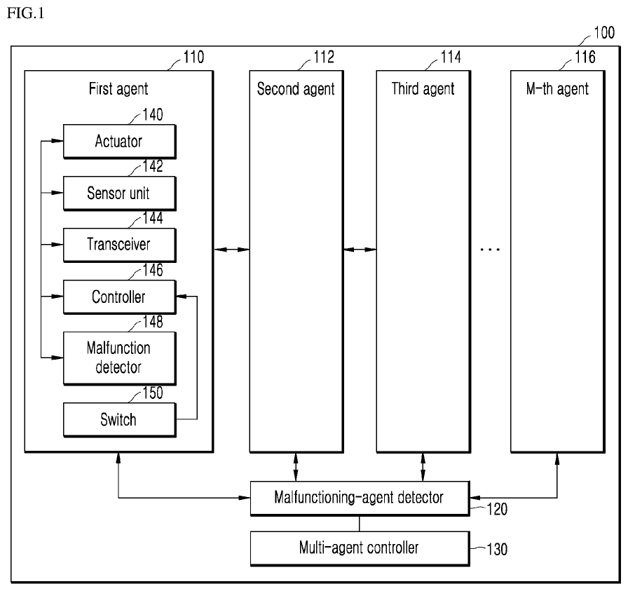

FIG. 1 illustrates a block diagram of a multi-agent control system that controls a plurality of agents to operate in a platoon, according to a preferred example embodiment of the present disclosure.

A multi-agent control system 100 includes a plurality of agents 110, 112, 114 and 116, a malfunctioning-agent detector 120 and a multi-agent controller 130.

In a preferred example embodiment of the present disclosure, the multi-agent control system 100 is a system that controls the plurality of agents 110, 112, 114 and 116 so that they can move together in a specific form or perform respective operations together. As an example, there are a vehicle platoon in which a plurality of vehicles move at regular intervals in a platoon on a highway, a drone platoon in which a plurality of drones fly in formation, and the like. Examples of the agent may include an autonomous vehicle, a self-flying drone, and the like.

In the present disclosure, each of the multiple agents 110, 112, 114 and 116 in the multi-agent control system 100 includes an actuator 140, a sensor unit 142, a transceiver 144, a controller 146, a malfunction detector 148, and a switch 150.

The sensor unit 142 may include various sensors, such as a GPS sensor, a speed sensor, a LiDAR sensor, and an image sensor, which are necessary for platoon. For example, in the case of a vehicle, the GPS sensor and the speed sensor may be assumed to be installed in a front portion of the vehicle, and the LiDAR sensor may be assumed to be installed in a central portion of the vehicle.

The transceiver 144 performs transmission and reception of data and communication.

The controller 146 controls the actuator 140, the sensor unit 142, and internal constituent elements of the agent such as a vehicle, a drone, or the like using internal control signals.

The malfunction detector 148 may generate a malfunction detection signal when detecting a malfunction of the actuator 140, the sensor unit 142, the transceiver 144 or the controller 146, and transmit the malfunction detection signal to the malfunctioning-agent detector 120. An example of the malfunction detection signal may be an alarm message.

In a preferred example embodiment of the present disclosure, the malfunction detector 148 may detect failure or malfunction of the actuator 140 by Mathematical formula 1 below.

$${\dot{z}}_{\text{?}} = ( \begin{matrix}{\dot{z}}_{1 , \text{?}} \\ {\dot{z}}_{2 , \text{?}}\end{matrix} ) = ( \begin{matrix}{z}_{2 , \text{?}} \\ \frac{1}{{m}_{\text{?}}} {d}_{\text{?}} ( {z}_{\text{?}} , {z}_{\text{?}} )\end{matrix} ) + ( \begin{matrix}0 \\ \frac{1}{{m}_{\text{?}}}\end{matrix} ) {u}_{\text{?}} - ( \begin{matrix}{θ}_{\text{?}} \\ {θ}_{\text{?}}^{2}\end{matrix} ) ( {{y}^{*}}_{\text{?}} - {y}_{i} ) \qquad [ Mathematical formula 1 ]$$

$${\hat{y}}_{\text{?}} = {z}_{\text{?}}$$

$${ζ}_{\text{?}} = \vert {\hat{y}}_{\text{?}} - {y}_{i} \vert$$

$$\text{?} \text{indicates text missing or illegible when filed}$$

In Mathematical formula 1 above, [symbol] represents an estimated vector of a state observer, [symbol] represents an output of the state observer, and [symbol] is defined as an absolute value of a difference between a position sensor output of a respective vehicle and the output of the state observer. Further, [symbol] represents an observer parameter.

The malfunction detector 148 may generate a malfunction detection signal when [symbol] exceeds a specific reference value [symbol] in Mathematical formula 1. The malfunction detection signal includes an alarm message. The vehicle, which is illustrated as an example of an agent in an example embodiment of FIG. 4, uses a disturbance observer DOBᵢ 460 (FIG. 4). Thus, when the malfunction detector 148 detects a failure of the actuator, the vehicle may cope with such a failure.

As a preferred example embodiment of the present disclosure, the malfunction detector 148 can detect the failure or malfunction of the sensor unit 142 using approaches expressed in Mathematical formulas 2 to 5.

$$\text{?} \qquad [ Mathematical formula 2 ]$$

$$\text{?} \qquad [ Mathematical formula 3 ]$$

$$\text{?} \qquad [ Mathematical formula 4 ]$$

$$\text{?} \qquad [ Mathematical formula 5 ]$$

$$\text{?} \text{indicates text missing or illegible when filed}$$

In Mathematical formulas 2 to 5 above, [symbol] represents a distance measured by the LiDAR sensor, [symbol] and [symbol] represent a position sensor output and a speed sensor output measured by a position sensor and a speed sensor provided in an i-th agent Vᵢ, respectively. [symbol] represents a differentiator, which is a high-pass filter, and [symbol] represents a vector obtained by differentiating [symbol] .

For the sake of convenience in description, [symbol] , [symbol] , [symbol] , and [symbol] are defined as follows:

$$\text{?} \\ \text{?} \\ \text{?} \\ \text{?}$$

$$\text{?} \text{indicates text missing or illegible when filed}$$

When a difference value between the sensor output measured by the sensor previously installed in one agent and an estimated sensor output received from another agent provided around the one agent changes, the malfunction detector 148 may determine that a failure has occurred in the sensor unit 142 installed in the one agent.

For example, when values of [symbol] and [symbol] increase, the malfunction detector 148 may estimate that a failure has occurred in the position sensor or the speed sensor. When an absolute value of [symbol] and [symbol] exceeds a preset position sensor threshold value [symbol] , a preset speed sensor threshold value [symbol] and the like, the malfunction detector 148 may detect that a failure has occurred in a respective sensor.

$$\text{?}$$

$$\text{?} \text{indicates text missing or illegible when filed}$$

In a preferred example embodiment of the present disclosure, the malfunctioning-agent detector 120 may collect information such as [symbol] , [symbol] , [symbol] , and [symbol] for all agents in the multi-agent control system 100, and may determine that a failure has occurred in any sensor of any agent based on the collected information.

In a preferred example embodiment of the present disclosure, the malfunction detector 148 may detect a malfunction of the controller 146 of an agent using a virtual general-rated controller. More specifically, the malfunction detector 148 may detect a malfunction of the controller 146 by comparing an internal control signal [symbol] of the controller 146 with a control signal [symbol] of the virtual general-rated controller.

Referring to FIG. 4, [symbol] may be expressed. When a difference between the internal control signal [symbol] and the control signal [symbol] the virtual general-rated controller is equal to or greater than a preset threshold value, the malfunction detector 148 may determine that a malfunction has occurred in the controller 146.

$$\text{?}$$

$$\text{?} \text{indicates text missing or illegible when filed}$$

When the malfunction detection signal is generated from the malfunction detector 148, the switch 150 performs switching such that the controller 146 uses a correction control signal that are directly received from the adjacent agent or the multi-agent controller 130 instead of the internal control signal.

In the multi-agent control system 100, the malfunctioning-agent detector 120 detects which agent among the plurality of agents 110, 112, 114 and 116 has caused a malfunction based on the malfunction detection signal received from each of the plurality of agents 110, 112, 114 and 116. The malfunctioning-agent detector 120 may generate an alarm message corresponding to the agent that has caused the malfunction.

The multi-agent controller 130 controls a peripheral agent around the malfunctioning agent detected by the malfunctioning-agent detector 120 to transmit a control signal to the malfunctioning agent so that the plurality of agents 110, 112, 114 and 116 operate in a platoon.

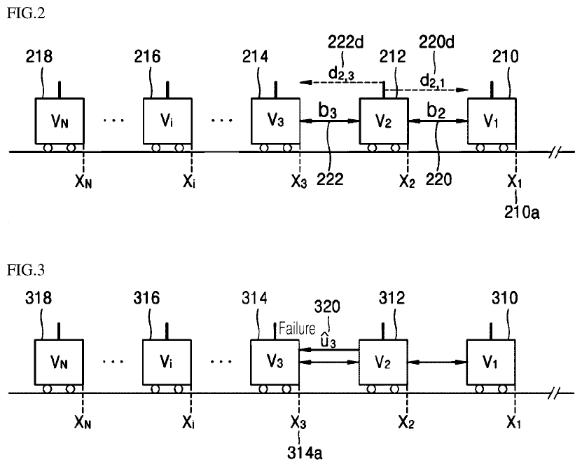

FIG. 2 illustrates an example in which an autonomous platooning is performed by the multi-agent control system 100 of FIG. 1 according to a preferred example embodiment of the present disclosure.

Vᵢ 210 represents an i-th agent, for example, an i-th vehicle, and a status of the vehicle Vᵢ 210a is defined as

$${x}_{i} = ( \begin{matrix}{s}_{i} \\ {v}_{i}\end{matrix} ) .$$

Sᵢ represents a current location of the i-th vehicle with reference to a side portion of Vᵢ, and vᵢ represents a current speed of the i-th vehicle. bᵢ 220, 222 represents an actual distance between the i-th vehicle and an (i−1)th vehicle. bᵢ may be measured by the LiDAR sensor. A distance d_{i,j} 220d, 222d measured by the LiDAR sensor means the distance from the center of the i-th vehicle to a j-th vehicle. For example, the distance d_{i,j} means a distance from the central portion of the i-th vehicle to a rear portion of the j-th vehicle. In encompass meaning of the direction for reference, d_{i,j} represents the measured distance from the LiDAR sensor of the i-th vehicle to the j-th vehicle, whereas d_{i,j} represents the measured distance from the LiDAR sensor of the j-th vehicle to the i-th vehicle.

In a preferred example embodiment of the present disclosure, it is assumed that a distance between adjacent agents among the plurality of agents controlled by the multi-agent control system 100 can be measured. For example, in the case in which the i-th vehicle Vi measures a distance to a rear vehicle Vᵢ₊₁, the distance from the i-th vehicle Vi to a front portion of the rear vehicle Vᵢ₊₁ may be assumed to be measured. Further, in the case in which the i-th vehicle Vᵢ measures a distance to a front vehicle the distance from the i-th vehicle Vi to a rear portion of the front vehicle Vᵢ₋₁ may be assumed to be measured.

In a preferred example embodiment of the present disclosure, the distance bi between adjacent agents, which is calculated by the measurement value of the LiDAR sensor in the multi-agent control system 100, is bᵢ=d_{i,i+1}−0.5lᵢ, and lᵢ represents a length of the i-th vehicle.

In a preferred example embodiment of the present disclosure, as long as the plurality of vehicles 210,212,214,216 and 218, which are being controlled by the multi-agent control system 100, do not malfunction, the multi-agent controller 130 (see FIG. 1) controls such that distances and speeds between the plurality of vehicles 210, 212, 214, 216 and 218 are substantially similar to each other.

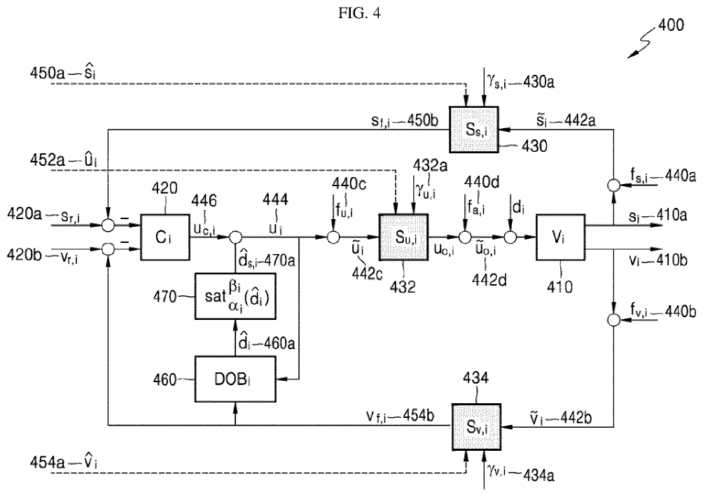

FIG. 3 illustrates an example in which, when a malfunction has occurred in one of a plurality of agents driving in the autonomous platooning malfunctions, a neighboring agent around the malfunctioning agent controls the malfunctioning agent according to a preferred example embodiment of the present disclosure.

In an example embodiment, each of the plurality of agents may be a vehicle or a drone.

In a preferred example embodiment of the present disclosure, descriptions will be made based on a premise that, when the plurality of vehicles (for example, N vehicles) are driving in an autonomous platooning, the multi-agent control system 100 already recognizes the arrangement state of the N vehicles.

In a preferred example embodiment of the present disclosure, when a malfunction has occurred in a certain agent under control of the multi-agent control system 100, the malfunctioning agent itself may determine the occurrence of the malfunction, or agents adjacent to or near to the malfunctioning agent among agents in an autonomous platooning or swarm flight may detect the malfunctioning agent. For example, the agents adjacent to or near to the malfunctioning agent may observe the malfunctioning agent in real time using a LiDAR sensor, a radar sensor, an image sensor and the like provided therein, and thus to estimate whether or not a malfunction has occurred. Herein, for the sake of easier understanding, the LiDAR sensor, the radar sensor and the image sensor have been described as examples, but malfunctions of adjacent vehicles, adjacent drones or the like may be detected with any equipment that can measure motions or speeds of adjacent vehicles, adjacent drones or the like in platooning or swarm flight.

In a preferred example embodiment of the present disclosure, when a malfunction has occurred in a certain agent under control of the multi-agent control system 100, the multi-agent control system 100 is configured such that at least one agent adjacent to the malfunctioning agent controls the malfunctioning agent. The at least one adjacent agent may be a single agent or a plurality of agents.

FIG. 3 illustrates an example in which when N vehicles are driving in a platoon, a malfunction has occurred in an agent V₃ 314. In a preferred example embodiment of the present disclosure, the malfunctioning-agent detector 120 (see FIG. 1) of the multi-agent control system 100 may directly receive status information x₃ 314a of the agent V₃ 314 to detect the malfunction of the agent V₃ 314, or grasp the status information x₃ 314a of the Agent V₃ 314 from at least one neighboring agent adjacent to the agent V₃ 314 to detect the malfunction of the agent V₃ 314.

In the example embodiment described with reference to FIG. 3, the example in which the malfunctioning agent is controlled using neighboring agents in a longitudinal direction has been described. However, it should be noted that the present disclosure may be applicable to an example in which the malfunctioning agent is controlled using neighboring agents in a lateral direction or other various angular directions.

When the malfunction of the agent V₃ 314 is detected, the multi-agent controller 130 (see FIG. 1) may transmit a correction control signal for controlling the agent V₃ 314 to an agent V₂ 312 neighboring the agent V₃ 314. The agent V2 312 may directly transmit, to the agent V₃ 314, a position estimation vector [symbol] and a velocity estimation vector [symbol] of the agent V₃ 314a, or may transmit, to the agent V₃ 314, a control input [symbol] calculated based on the position estimation vector [symbol] and the velocity estimation vector [symbol] of the agent V₃ 314.

FIG. 4 illustrates a control system 400 for controlling the i-th agent in an autonomous platooning according to a preferred example embodiment of the present disclosure.

In FIG. 4, V₁ 410, C₁ 420, S_{s,1} 430, and S_{u,1} 432, and S_{v,1} 434 represents the i-th agent, the controller 146, a position switch, a control input switch, and a speed switch, respectively. γ_{s,l} 430a, γu,l 432a, and γ_{v,i} 434a represent alarm messages issued when malfunctions have occurred in the position sensor of a sensor unit 142, the controller 146, and the speed sensor of the sensor unit 142, respectively.

FIG. 4 illustrates an example in which the switch 150 (see FIG. 1) is divided into a position switch 430, a speed switch 434, and a control input switch 432 in a preferred example embodiment of the present disclosure. That is, the switch 150 may include the position switch 430, the control input switch 432, and the speed switch 434.

[symbol] 442a and [symbol] 442b represent a current position and speed of the vehicle measured by the position sensor and the speed sensor of the agent V₁ 410, respectively. [symbol] 420a and [symbol] 420b represent a position reference vector and a velocity reference vector to be applied to the agent Vi 410, respectively. [symbol] 440a, [symbol] 440b, [symbol] 440c, and [symbol] 440d represent a malfunction detection signal of the position sensor, a failure signal of the speed sensor, a malfunction detection signal of the controller 146, and a malfunction detection signal generated by the malfunction detector 148 when a malfunction has occurred in the actuator 140, respectively. When no failure occurs, values of the malfunction signals, [symbol] 440a, [symbol] 440b, [symbol] 440c, and [symbol] 440d are zero, respectively. [symbol] 442a, [symbol] 442b, [symbol] 442c, and [symbol] 442d represent signals modified by the malfunction signals [symbol] 440a, [symbol] 440b, [symbol] 440c, and [symbol] 440d, respectively.

When the position switch [symbol] 430 receives the failure alarm message [symbol] [symbol] 430a as the malfunction signal from the position sensor malfunction detector, the position switch [symbol] 430 uses the correction control signal [symbol] 450a instead of the position sensor output [symbol] 442a of the agent Vᵢ 410. The position estimation vector [symbol] 450a represents a position vector of the agent Vᵢ 410, which is estimated by an agent adjacent to the agent Vᵢ 410. In this case, the position vector may be expressed as [symbol] . In other words, when an error does not occur in the position sensor, the position switch [symbol] 430 uses the position sensor output [symbol] 442a of the agent Vᵢ 410. However, when an error does not occur in the position sensor, the position switch [symbol] 430 performs switching to use the correction control signal [symbol] 450a as the position estimation vector [symbol] of the agent Vᵢ 410, which is estimated by an agent adjacent to the agent Vi 410.

When receiving [symbol] [symbol] 432a or the malfunction signal [symbol] 440c, the control input switch [symbol] 432 uses the correction control signal [symbol] 454a instead of the internal control signal [symbol] 442c of the agent Vᵢ 410, which is affected by the malfunction signal [symbol] 440c. The correction control signal [symbol] 452a represents a control input calculated based on the state

$${x}_{i} = ( \begin{matrix}{s}_{i} \\ {v}_{i}\end{matrix} )$$

of the agent Vᵢ 410 through the LiDAR sensor or the like provided in an agent adjacent to the agent Vᵢ 410. Here, sᵢ 410a and vᵢ 410b mean an actual position and an actual speed of the agent Vᵢ 410, respectively.

When receiving γ_{v,1}434a or the malfunction signal [symbol] 440b, the speed switch [symbol] 434 uses the correction control signal [symbol] 454a instead of the speed sensor output [symbol] 442b of the agent Vᵢ 410, which is affected by the malfunction signal [symbol] 440b. The velocity estimation vector [symbol] 454a represents a velocity vector estimated by an agent adjacent to the agent Vᵢ 410.

In a preferred example embodiment of the present disclosure, the control system 400 may include the disturbance observer DOBᵢ 460. The disturbance observer DOBᵢ 460 is designed to compensate for a disturbance [symbol] the agent, and calculates a disturbance compensation signal estimation vector [symbol] 460a based on an internal control signal [symbol] and a feedback signal [symbol] 454b. The disturbance compensation signal estimation vector [symbol] 460a is transformed in a saturator 470 to improve a transient performance. The transformed signal is represented as [symbol] 470a.

The saturator [symbol] 470 is a function expressed by the lowest limit vector [symbol] and the maximum limit vector [symbol] . The function is defined as [symbol] for [symbol] , as [symbol] for [symbol] , and as [symbol] in other domains.

The signals [symbol] 446 and [symbol] 444 represent a control input calculated by the controller 420, and a control input calculated by being coupled with the signal from the disturbance observer DOBᵢ 460, respectively.

For example, when the agent is a vehicle, a dynamic model for the vehicle may expressed as follows:

$${\dot{x}}_{\text{?}} = ( \begin{matrix}{\dot{s}}_{\text{?}} \\ {\dot{v}}_{\text{?}}\end{matrix} ) = ( \begin{matrix}{v}_{\text{?}} \\ \frac{1}{{m}_{\text{?}}} {d}_{\text{?}} ( {s}_{\text{?}} , {v}_{\text{?}} )\end{matrix} ) + ( \begin{matrix}0 \\ \frac{1}{{m}_{\text{?}}}\end{matrix} ) {\tilde{u}}_{\text{?}} - {y}_{i} = {\tilde{s}}_{\text{?}}$$

$$\text{?} \text{indicates text missing or illegible when filed}$$

where, the disturbance [symbol] received by the vehicle may be assumed to include influence of the slope of the road, influence of friction between the tire and the ground, and influence caused by air resistance and the like. In this case, the disturbance [symbol] may be expressed as follows:

$${d}_{i} ( {s}_{i} , {v}_{i} ) = - {m}_{i} g sin ( α ( {s}_{i} ) ) - {c}_{r , i} {m}_{i} g cos ( α ( {s}_{i} ) ) - \frac{1}{2} ρ {A}_{v} {C}_{D} ( {b}_{i} ) {v}_{i}^{2}$$

where, [symbol] is the mass of the i-th vehicle, [symbol] is the acceleration due to gravity, [symbol] means the road slope at [symbol] , [symbol] represents the friction coefficient, [symbol] represents the air density, and [symbol] represents the air coefficient determined by the distance between vehicles. In this case, the output [symbol] 446 of the controller Cᵢ 420 may be expressed as follows:

$${u}_{c , i} = {K}_{g , i} ( {s}_{r , i} - {s}_{f , i} ) + {K}_{v , i} ( {v}_{r , i} - {v}_{f , i} )$$

[symbol] represents a controller configured to adjust a distance from the vehicle in front, and [symbol] represents a velocity reference vector. That is, [symbol] represents a speed controller that enables following of the velocity reference vector [symbol] 420b.

In a preferred example embodiment of the present disclosure, the disturbance observer DOBᵢ 460 may be expressed as follows:

$$[ \begin{matrix}{\dot{p}}_{1 , i} \\ {\dot{p}}_{2 , i}\end{matrix} ] = [ \begin{matrix}0 & 1 \\ - \frac{{a}_{0 , i}}{{τ}_{i}^{2}} & - \frac{{a}_{1 , i}}{{τ}_{i}}\end{matrix} ] [ \begin{matrix}{p}_{1 , i} \\ {p}_{2 , i}\end{matrix} ] + [ \begin{matrix}0 \\ \frac{{a}_{0 , i}}{{τ}_{i}^{2}}\end{matrix} ] {u}_{i}$$

$$[ \begin{matrix}{\dot{q}}_{1 , i} \\ {\dot{q}}_{2 , i}\end{matrix} ] = [ \begin{matrix}0 & 1 \\ - \frac{{a}_{0 , i}}{{τ}_{i}^{2}} & - \frac{{a}_{1 , i}}{{τ}_{i}}\end{matrix} ] [ \begin{matrix}{q}_{1 , i} \\ {q}_{2 , i}\end{matrix} ] + [ \begin{matrix}0 \\ \frac{{a}_{0 , i}}{{τ}_{i}^{2}}\end{matrix} ] {v}_{f , i}$$

$${\hat{d}}_{i} = {m}_{i} {q}_{2 , 1} - {p}_{1 , i}$$

where, [symbol] and [symbol] represent state variables of the disturbance observer DOBᵢ 460, [symbol] , [symbol] and [symbol] represent design parameters of the disturbance observer DOBᵢ 460.

In a preferred example embodiment of the present disclosure, the reference vectors [symbol] 420a and [symbol] 420b to be referenced by the vehicle Vi may be defined as a function for the state of the front vehicle Vᵢ₋₁. The vehicle Vᵢ may determine whether to use position data or speed data of the front vehicle Vᵢ₋₁ according to whether the front vehicle Vᵢ₋₁ malfunctions. For example, when it is determined that the front vehicle Vᵢ₋₁ is in a malfunctioning state, the vehicle Vᵢ generates and uses the reference vector [symbol] based on an estimation vector of the position of the front vehicle Vᵢ₋₁, instead of using the position sensor output [symbol] transmitted from the front vehicle Vᵢ₋₁.

In a preferred example embodiment of the present disclosure, the position sensor output [symbol] 420a of the vehicle Vᵢ may be set as follows:

When the position sensor of the front vehicle Vᵢ₋₁ is normal, that is, when an alarm— [symbol] [symbol] is not generated, [symbol] is set. When the position sensor of the front vehicle Vᵢ₋₁ malfunctions, that is, when the alarm [symbol] [symbol] is generated, [symbol] is set. In this case, [symbol] represents a reference vector for the distance between the vehicles.

In a preferred example embodiment of the present disclosure, the velocity reference vector [symbol] 420b of the vehicle Vᵢ may be set as follows:

When the speed sensor of the front vehicle Vᵢ₋₁ is normal, that is, when an alarm [symbol] [symbol] is not generated, [symbol] is set. When the speed sensor of the front vehicle Vᵢ₋₁ malfunctions, that is, when the alarm [symbol] [symbol] is generated, [symbol] is set. In this case, [symbol] represents a velocity reference vector of the front vehicle Vᵢ₋₁, where [symbol] is a positive value smaller than 1 and means a turning parameter.

An example embodiment of the present disclosure may be implemented in the form of a recording medium incorporating instructions executable by a computer, such as a computer-executable program module. A computer-readable medium may be any available medium that can be accessed by the computer, and may be a volatile and non-volatile medium, removable and non-removable medium. Further, the computer-readable medium may include a computer storage medium. The computer storage medium may be a volatile and non-volatile, removable and non-removable medium implemented by any method or technology for storage of information such as computer-readable instructions, data structures, program modules or other data.

While the method and system according to the present disclosure have been described with reference to specific example embodiments, some or all of constituent elements or operations thereof may be implemented using a computer system with a general-purpose hardware architecture.

The foregoing description of the present disclosure is merely an example. It will be understood by those skilled in the art that variations are readily possible in other specific forms without changing the technical ideas or essential features of the present disclosure. Therefore, it should be noted that the example embodiments described above are exemplary in all respects and are not restrictive. For example, each element that is described in a single form may be embodied in a distributed fashion. Similarly, elements that are described in the distributed fashion may be embodied in a combined fashion.

The scope of the present disclosure should be construed within the appended claims rather than the foregoing detailed description, and it is intended that all changes or modifications that come from the meaning and scope of the claims and their equivalent concept be embraced therein.

### STATEMENT REGARDING GOVERNMENT SUPPORT

This invention was supported at least in part by Ministry of Science and ICT of South Korean government for research project, the title of which is “Resilient Cyber-Physical Systems Research”(Project Number: 1711103319) managed by IITP (Institute of Information & Communications Technology Planning & Evaluation).

What is claimed is:

1. A multi-agent control system for controlling a plurality of agents to operate in a platoon,
wherein each of the plurality of agents includes:
an actuator;
a sensor unit including at least one sensor;
a controller configured to control the actuator, the sensor unit, and each agent using an internal control signal;
a malfunction detector configured to generate a malfunction signal by detecting a malfunction of the actuator, the sensor unit, or the controller; and
a switch configured to perform a switching operation based on the malfunction signal such that the controller uses a correction control signal received from at least one neighboring agent among the plurality of agents instead of the internal control signal,
the multi-agent control system comprising:
a malfunctioning-agent detector configured to detect a malfunctioning agent among the plurality of agents based on the malfunction signal received from each of the plurality of agents; and
a multi-agent controller configured to control the at least one neighboring agent to transmit the correction control signal to the malfunctioning agent such that the plurality of agents operate in the platoon.

2. The multi-agent control system of claim 1, wherein the correction control signal is generated based on a position estimation vector and a velocity estimation vector of the malfunctioning agent, which are calculated by the at least one neighboring agent.

3. The multi-agent control system of claim 1, wherein the malfunction detector is configured to detect an error of the sensor unit provided in an i-th agent Vᵢ based on differences between a position estimation vector [symbol] and a velocity estimation vector [symbol] of a neighboring agent Vᵢ₊₁ around the i-th agent Vᵢ, which are calculated by the i-th agent V₁ among the plurality of agents, and a position data vector \tilde{s}ᵢ₊₁ and a velocity data vector \tilde{v}ᵢ₊₁ which are actually measured by the neighboring agent Vᵢ₊₁, which are received from the neighboring agent Vᵢ₊₁.

4. The multi-agent control system of claim 1, wherein the at least one neighboring agent is configured to monitoring a state of the malfunctioning agent using the sensor unit provided in the at least one neighboring agent in real time and calculate a position estimation vector [symbol] and a velocity estimation vector of the malfunctioning agent.

5. The multi-agent control system of claim 3, wherein the sensor unit includes a LiDAR sensor and a GPS sensor,
the position estimation vector [symbol] of the neighboring agent Vᵢ₊₁ is calculated based on a distance between the i-th agent Vᵢ and the at least one neighboring agent Vᵢ₊₁, which is measured by the LiDAR sensor of the i-th agent Vᵢ, and a current position of the i-th agent Vᵢ, which is measured by the GPS sensor of the i-th agent Vᵢ,
the velocity estimation vector Q of the neighboring agent Vᵢ₊₁ is calculated based on a vector obtained by differentiating the distance between the i-th agent Vᵢ and the neighboring agent Vᵢ₊₁, which is measured by the LiDAR sensor of the i-th agent Vᵢ, and a current speed of the i-th agent Vᵢ, which is measured by the i-th agent Vᵢ, and
the malfunction detector determines that an error has occurred in the sensor unit based on the differences between the position estimation vector [symbol] and the velocity estimation vector R of the neighboring agent Vᵢ₊₁, which is calculated by the i-th agent Vᵢ, and the position data vector \tilde{s}ᵢ₊₁ and the velocity data vector \tilde{v}ᵢ₊₁ which are actually measured by the neighboring agent Vᵢ₊₁.

6. The multi-agent control system of claim 1, wherein, when a difference between a virtual control signal value, which is calculated based on a value obtained by subtracting a disturbance compensation signal for compensating for a disturbance di of the i-th agent Vᵢ from a reference control signal value of the i-th agent Vᵢ, and the internal control signal value, exceeds a preset threshold value, the malfunction detector determines that a malfunction has occurred in the controller, the reference control signal value being generated based on the position reference vector s_{r,i} and the velocity reference vector v_{r,i} to be referenced by the i-th agent Vᵢ to operate in the platoon.

7. The multi-agent control system of claim 1, wherein the malfunctioning-agent detector is configured to collect information about a difference value of at least one sensor output between the i-th agent Vᵢ and a front agent Vᵢ₋₁, and a difference value of at least one sensor output between the i-th agent Vᵢ and a rear agent Vᵢ₊₁, and to detect the malfunctioning agent based on the collected information.

8. The multi-agent control system of claim 7, wherein the malfunctioning-agent detector is configured to detect a sensor in which a failure has occurred, among the at least one sensor of the malfunctioning agent.

9. A multi-agent control system, comprising:
a plurality of agents; and
a multi-agent controller configured to communicate with the plurality of agents to control the plurality of agents,
wherein each of the plurality of agents includes a sensor unit, a transceiver, and a malfunction detector,
wherein the malfunction detector is configured to transmit malfunction information of a malfunctioning agent to the multi-agent controller through the transceiver,
when receiving the malfunction information from the malfunction detector, the multi-agent controller is configured to select at least one neighboring agent, which is capable of controlling the malfunctioning agent from which the malfunction information is transmitted among the plurality of agents, and connect the selected at least one neighboring agent and the malfunctioning agent to establish the communication therebetween, and
the selected at least one neighboring agent is configured to transmit a state estimation vector of the malfunctioning agent to the malfunctioning agent to control the malfunctioning agent.

10. The multi-agent control system of claim 9, wherein the multi-agent controller is configured to generate a command signal for allowing the selected at least one neighboring agent to transmit the state estimation vector of the malfunctioning agent to the malfunctioning agent, and configured to transmit the command signal to the selected at least one neighboring agent.

11. The multi-agent control system of claim 9, wherein the selected at least one neighboring agent is configured to observe a motion of the malfunctioning agent in real time to calculate the state estimation vector of the malfunctioning agent, and configured to transmit the state estimation vector of the malfunctioning agent to the malfunctioning agent.

12. The multi-agent control system of claim 11, wherein the observing the motion of the malfunctioning agent in the real-time is performed by a sensor unit of the selected at least one neighboring agent.

13. The multi-agent control system of claim 9, wherein the malfunctioning agent is configured to operate using, as a correction control signal, the state estimation vector received from the at least one neighboring agent, instead of an internal control signal generated by the malfunctioning agent.
